(19) United States
(12) Patent Application Publication
(10) Pub. No.: US 2006/0206247 A1
(43) Pub. Date: Sep. 14, 2006

(54) Tire parameter sensing system having a tire-based unit that is responsive to a trigger signal and associated method

(75) Inventor: Xing Ping Lin, Orchard Lake, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignees: TRW Automotive U.S. LLC; Societe de Technologie MICHELIN

(21) Appl. No.: 11/075,681

(22) Filed: Mar. 9, 2005

(51) Int. Cl. G01M 17/00

(52) U.S. Cl. 701/29; 701/35; 701/33

(57) ABSTRACT

A tire parameter sensing system (12) for a vehicle (10) includes a vehicle-based unit (54) and a tire-based unit (34). The tire-based unit (34) is associated with a tire (16) and rotates with the tire. The tire-based unit (34) is located in a communication zone (190) for communicating with the vehicle-based unit (54) through only a portion of each rotation of the tire (16). The tire-based unit (34) senses at least one parameter of the tire (16) and transmits locator signals at predetermined intervals. The vehicle-based unit (54) receives a locator signal that is transmitted while the tire-based unit (34) is located in the communication zone (190) and, in response to receiving the locator signal, transmits a trigger signal to the tire-based unit (34). The tire-based unit (34) is responsive to receipt of the trigger signal for transmitting a parameter signal indicative of the sensed at least one parameter.

### TECHNICAL FIELD

The present invention relates to a tire parameter sensing system for a vehicle and an associated method. More particularly, the present invention relates to a tire parameter sensing system in which a tire-based unit is responsive to a trigger signal from the vehicle-based unit for transmitting a parameter signal indicating sensed tire parameters and an associated method.

### BACKGROUND OF THE INVENTION

Tire parameter sensing systems for vehicles typically include multiple tire-based units and a single vehicle-based unit. Each tire-based unit has an associated tire of the vehicle and is operative to sense at least one parameter of the tire. The sensed parameter(s) may include temperature, pressure, etc. Each tire-based unit is also operative to transmit a parameter signal indicative of the sensed parameter(s) to the vehicle-based unit. The vehicle-based unit is connected to a display. In response to receiving a parameter signal from a tire-based unit, the vehicle-based unit outputs a signal to the display. The display is responsive to the signal for displaying the sensed tire parameter(s).

It is common for the tire-based units of a tire parameter sensing system to be battery powered. Battery powered tire-based units, however, have specific limitations, for example, a limited life, a limited current supply, and a limited operating temperature range. The design of a tire parameter sensing system using battery powered tire-based units must be mindful of these limitations. As a result, it is common for a battery powered tire-based unit to transmit parameter signals only in response to a determination that a sensed parameter is outside of a desired range. For example, if the desired pressure range is 32 to 36 pounds per square inch (“psi”), the battery powered tire-based unit may transmit a parameter signal to the vehicle-based unit only when the sensed tire pressure is determined to be below 32 psi or above 36 psi. By limiting the transmissions of the parameter signal, the battery life of the battery powered tire-based unit may be extended.

In some tire parameter sensing systems, the tire-based units do not include batteries. Tire-based units that do not include batteries receive energy via magnetic or electric field coupling of the tire-based unit with an associated energy transmitting component of the vehicle-based unit. The associated energy transmitting component of the vehicle-based unit is generally located near the tire-based unit, such as in the wheel well of the vehicle.

The tire-based unit generally includes a capacitor that is charged by magnetic or electric field coupling. The tire-based unit uses the energy stored in the capacitor for sensing the parameter(s) in the tire and for providing a parameter signal indicative of the sensed tire parameter(s). The tire-based unit may include signal transmission circuitry, including an oscillator, for transmitting a tire parameter signal to the vehicle-based unit. Alternatively, the tire-based unit may use the principal known as “backscatter modulation” to transfer a tire parameter signal to the vehicle-based unit.

It is common for the tire-based unit to be fixed for rotation with its associated tire. During the rotation of the tire relative to the vehicle, the tire-based unit moves relative to the associated energy transmitting component of the vehicle-based unit. During a portion of each rotation of the tire, the rim upon which the tire is mounted becomes interposed between the tire-based unit and associated energy transmitting component of the vehicle-based unit. When the rim is located between the tire-based unit and the associated energy transmitting component of the vehicle-based unit, the rim may block signal transmissions between the tire-based unit and the associated energy transmitting component of the vehicle-based unit. Additionally, when the tire-based unit is located at certain rotational positions relative to the vehicle, attenuation of the tire parameter signal may occur as the tire parameter signal passes through the structure of the tire. As a result, a signal to noise ratio of a tire parameter signal that is received by the vehicle-based unit may be too low for enabling the vehicle-based unit to accurately extract the sensed tire parameter(s).

A communication zone exists for each tire-based unit and its associated energy transmitting component of the vehicle-based unit. When the tire-based unit is located within the communication zone, communication between the tire-based unit and the associated energy transmitting component of the vehicle-based unit is likely to occur. The tire-based unit passes into and out of the communication zone during rotation.

The tire-based unit requires a certain amount of the energy stored in the capacitor for transmitting a tire parameter signal. When the tire-based unit transmits a tire parameter signal while outside of the communication zone, the energy used for transmitting the signal may be wasted as it is unlikely that the vehicle-based unit will receive the transmitted tire parameter signal. It is desirable to increase the success rate of communication from the tire-based unit to the vehicle-based unit. An increased success rate of the communication will enable the use of a smaller capacitor in the tire-based unit. As a result, the tire period necessary for charging the capacitor will be decreased and a response time for the system may be increased.

### SUMMARY OF THE INVENTION

The present invention relates to a tire parameter sensing system for a vehicle. The system comprises a vehicle-based unit and a tire-based unit. The tire-based unit is associated with a tire of the vehicle and rotates with the tire. The tire-based unit is located in a communication zone for communicating with the vehicle-based unit through only a portion of each rotation of the tire. The tire-based unit senses at least one parameter of the tire and transmits locator signals at predetermined intervals. The vehicle-based unit receives a locator signal that is transmitted while the tire-based unit is located in the communication zone and, in response to receiving the locator signal, transmits a trigger signal to the tire-based unit. The tire-based unit is responsive to receipt of the trigger signal for transmitting a parameter signal indicative of the sensed at least one parameter.

According to another aspect, the present invention relates to a tire parameter sensing system for a vehicle. The system comprises a tire-based unit that is associated with a tire of the vehicle and that rotates with the tire. The system also comprises a vehicle-based unit having a reader portion that is mounted on the vehicle at a location adjacent the tire to which the tire-based unit is associated. The vehicle-based unit is configured to communicate with the tire-based unit when the tire-based unit is located in a communication zone with the reader portion. The tire-based unit is located in the communication zone with the reader portion through only a portion of each rotation of the tire. The tire-based unit includes a parameter sensing portion for sensing at least one parameter of the tire and a communication portion for communicating with the vehicle-based unit. The communication portion of the tire-based unit transmits locator signals at predetermined intervals. The vehicle-based unit is responsive to receipt of a locator signal for transmitting a trigger signal from the reader portion to the tire-based unit. The communication portion of the tire-based unit, in response to receiving the trigger signal, transmits to the vehicle-based unit a parameter signal indicative of the at least one parameter of the tire.

In accordance with yet another aspect, the present invention relates to a method of operating a tire parameter sensing system of a vehicle in which a tire-based unit is associated with a tire of the vehicle and rotates with the tire. The tire-based unit is located in a communication zone with a vehicle-based unit through only a portion of each rotation of the tire. The method comprises the steps of sensing, with the tire-based unit, at least one parameter of the tire; transmitting locator signals from the tire-based unit at predetermined intervals; transmitting a trigger signal from the vehicle-based unit to the tire-based unit in response to receipt of a locator signal at the vehicle-base unit, and transmitting a parameter signal indicative of the at least one parameter of the tire from the tire-based unit to the vehicle-based unit in response to receipt of the trigger signal at the tire-based unit.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 schematically illustrates a vehicle including a tire parameter sensing system constructed in accordance with an exemplary embodiment of the present invention;

FIG. 2 is a schematic block diagram of a central portion of a vehicle-based unit of the tire parameter sensing system of FIG. 1;

FIG. 3 is a schematic block diagram of a reader portion of the vehicle-based unit and a tire-based unit of the tire parameter sensing system of FIG. 1;

FIG. 4 illustrates a wheel assembly of the vehicle having an associated tire-based unit and being located in a wheel well of the vehicle adjacent an associated reader portion of the vehicle-based unit;

FIG. 5, lines (a)-(d) graphically illustrate the transmission and receipt of signals by a tire-based unit and associated reader portion of a vehicle-based unit of the tire parameter sensing system of the present invention and, line (e) graphically illustrates a charge stored in an energy storage device of the tire-based unit;

FIG. 6 is a flow diagram illustrating an exemplary process performed by a tire-based unit of the tire parameter sensing system of the present invention;

FIG. 7 is a flow diagram illustrating an exemplary process performed by a vehicle-based unit of the tire parameter sensing system of the present invention; and

FIG. 8 is a schematic block diagram of a vehicle-based unit of a tire parameter sensing system constructed in accordance with a second embodiment of the present invention.

### DETAILED DESCRIPTION OF THE INVENTION

FIG. 1 schematically illustrates a vehicle 10 including a tire parameter sensing system 12 constructed in accordance with the present invention. For illustrative purposes, the vehicle 10 of FIG. 1 is an automobile having four tires 16, 18, 20, and 22. The tire parameter sensing system of the present invention can be used with vehicles having a number of tires other than four.

The vehicle 10 has a front 24, a rear 26, and opposite left and right sides 28 and 30, respectively. FIG. 1 illustrates tire 16 at a front left corner location of the vehicle 10. Tire 18 is located at a front right corner location of the vehicle 10. Tire 20 is located at a rear left corner location of the vehicle 10 and tire 22 is located at a rear right corner location of the vehicle 10.

The tire parameter sensing system 12 includes four tire-based units 34, 36, 38, and 40. Each tire 16, 18, 20, and 22 of the vehicle 10 includes an associated tire-based unit 34, 36, 38, and 40, respectively, for sensing at least one parameter, e.g., pressure, temperature, etc., of the tire and for transmitting parameter signals 44, 46, 48, and 50, respectively. The parameter signals 44, 46, 48, and 50 are indicative of the sensed parameter(s) of the tires 16, 18, 20, and 22, respectively.

The tire parameter sensing system 12 also includes a vehicle-based unit 54. The vehicle-based unit 54 includes a central portion 56 and four reader portions 60, 62, 64, and 66. One of the reader portions 60, 62, 64, and 66 of the vehicle-based unit 54 is associated with each one of the tire locations of the vehicle 10. Preferably, each reader portion 60, 62, 64, and 66 is located in the wheel well at its associated tire location. Each reader portions 60, 62, 64, and 66 of the vehicle-based unit 54 is also associated with the tire-based unit 16, 18, 20, and 22 of the tire located in its associated tire location. With reference to FIG. 1, reader portion 60 is associated with tire-based unit 34 of tire 16. Reader portion 62 is associated with tire-based unit 36 of tire 18. Reader portion 64 is associated with tire-based unit 38 of tire 20 and, reader portion 66 is associated with tire-based unit 40 of tire 22. Each reader portion 60, 62, 64, and 66 is configured for receiving the parameter signal 44, 46, 48, or 50 transmitted by the tire based-unit 16, 18, 20, or 22 to which it is associated.

Each reader portion 60, 62, 64, and 66 of the vehicle-based unit 54 is coupled to the central portion 56 of the vehicle-based unit. FIG. 1 schematically illustrates two lines connecting each reader portion 60, 62, 64, and 66 to the central portion 56. Lines 70 and 72 connect reader portion 60 to the central portion 56. Lines 74 and 76 connect reader portion 62 to the central portion 56. Lines 80 and 82 connect reader portion 64 to the central portion 56 and, lines 84 and 86 connect reader portion 66 to the central portion 56.

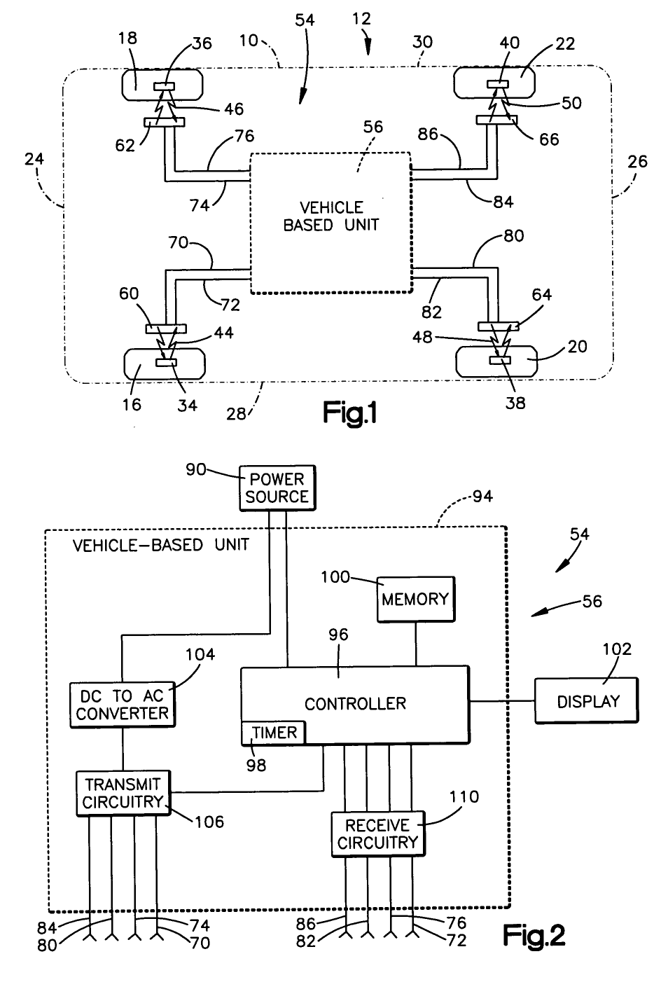

FIG. 2 schematically illustrates the central portion 56 of the vehicle-based unit 54 of the tire parameter sensing system 12 of FIG. 1. The vehicle-based unit 54 receives electrical power from a power source 90. The power source 90 preferably includes the battery of the vehicle 10 and an appropriate voltage regulator (not shown). The electrical power supplied to the vehicle-based unit 54 is regulated, direct current power have a generally constant voltage.

The central portion 56 of the vehicle-based unit 54 is preferably located within a housing 94. In the embodiment illustrated in FIG. 2, the central portion 56 of the vehicle-based unit 54 includes a controller 96. The controller 96 is preferably a microcomputer. Alternatively, the controller 96 may be formed from discrete circuitry, an application-specific-integrated-circuit (“ASIC”), or any other type of control circuitry. As an alternative to controller 96, each reader portion 60, 62, 64, and 66 of the vehicle-based unit 54 may include a controller. As illustrated schematically in FIG. 2, the controller 96 includes an internal timer 98.

A memory 100 is operatively connected to the controller 96. Alternatively, the memory 100 may form a portion of the controller 96. The memory 100 is a non-volatile memory that includes a lookup table for associating each reader portion 60, 62, 64, and 66 to its associated tire location on the vehicle 10. The memory 100 also stores a tire parameter sensing algorithm that is performed by the controller 100 of the vehicle-based unit 54.

A display 102 is operatively connected to the controller 96. The display 96 is located in the occupant compartment of the vehicle 10 and is responsive to receipt of display signals from the controller 96 for providing an operator of the vehicle with indications of the sensed tire parameter(s) and, optionally, the associated tire locations. For example, the display 102 may provide an indication of the sensed tire temperatures and the sensed tire pressures for each of the tires 16, 18, 20, and 22 of the vehicle 10.

The central portion 56 of the vehicle-based unit 54 also includes a direct current (“DC”) to alternating current (“AC”) converter 104, such as an oscillator. The DC to AC converter 104 receives a direct current from the power source 90 and outputs electrical energy having an alternating current. The alternating current is received by transmit circuitry 106 of the vehicle-based unit 54. The transmit circuitry 106 includes a relay circuit (not shown) that is operatively coupled to the controller 96. The controller 96 controls the relay circuitry 106 for controlling the output of the alternating current to the reader portions 60, 62, 64, and 66 of the vehicle-based unit 54 via lines 70, 74, 80, and 84, respectively. The transmit circuitry 106 also includes a modulator (not shown). The modulator is responsive to signals from the controller 96 for modulating information onto the alternating current that is provided to the reader portions 60, 62, 64, and 66. The modulator may use any known modulation method, such as amplitude shift keying or frequency shift keying.

The central portion 56 of the vehicle-based unit 54 also includes receive circuitry 110. The receive circuitry 110 includes a demodulator (not shown) for demodulating the received parameter signals 44, 46, 48, and 50 and for outputting message packets received in the parameter signals to a controller 96. Each message packet includes the sensed tire parameter(s).

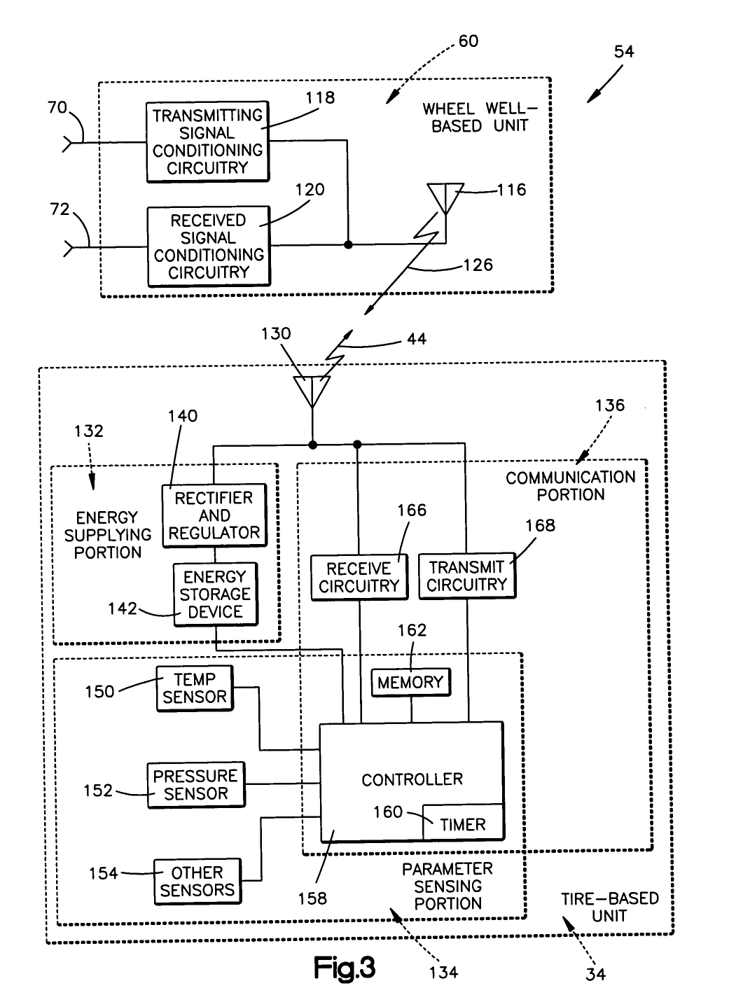

FIG. 3 illustrates reader portion 60 of the vehicle-based unit 54. Reader portions 62, 64, and 66 may have structures similar to reader portion 60 and may operate in a manner similar to reader portion 60. As is shown in FIG. 3, the reader portion 60 includes an antenna 116. Electric power having an alternating current is provided to the reader portion 60 via line 70. The reader portion 60 also includes transmitting signal conditioning circuitry 118 and received signal conditioning circuitry 120. The transmitting signal conditioning circuitry 118 includes components such as amplifiers and filters. The received signal conditioning circuitry 120 includes components such as filters.

The antenna 116 of the reader portion 60 of the vehicle-based unit 54 is responsive to receipt of electric power for providing a signal 126 to couple the reader portion 60 to the tire-based unit 34 to which it is associated. Either magnetic field coupling or electric field coupling may be used for coupling the reader portion 60 to the tire-based unit 34. In an exemplary embodiment of the invention, the antenna 116 is a coil that is configured for providing a low frequency signal at approximately 125 kHz to create a magnetic field for inductively coupling the reader portion 60 and the tire-based unit 34. The antenna 116 is also configured to receive signals from the tire-based unit 34 and to transfer the received signals to the central portion 56 of the vehicle-based unit 54 so that the signals may be demodulated and sent to the controller 96.

FIG. 3 also schematically illustrates the tire-based unit 34 of the tire parameter sensing system 12 of FIG. 1. Tire-based units 36, 38, and 40 may have structures similar to tire-based unit 34 and may operate in a manner similar to tire-based unit 34. The tire-based unit 34 includes an antenna 130 that is configured to be electrically or magnetically coupled to the antenna 116 of the reader portion 60. In the exemplary embodiment in which antenna 116 is a coil that provides a low frequency signal at approximately 125 kHz, antenna 130 is also a coil in which electrical energy, i.e., a voltage and a current, is induced. The electrical energy that is induced in the antenna 130 of the tire-based unit 34 has an alternating current.

The tire-based unit 34 also includes an energy supplying portion 132, a parameter sensing portion 134, and a communication portion 136. The energy supplying portion 132 includes rectifying and regulating circuitry 140. The rectifying and regulating circuitry 140 receives the electric energy from the antenna 130, converts the alternating current of the received electrical energy to direct current, and outputs electrical energy having a regulated direct current. The rectifying and regulating circuitry 140 provides the rectified and regulated electrical energy to an energy storage device 142, such as a capacitor, which provides the electrical energy for operation of the tire-based unit 34. The energy storage device 142 of the energy supplying portion 132 of the tire-based unit 34 supplies electrical energy to the components of the parameter sensing portion 134 and the communication portion 136 that require electrical energy for operation of the tire-based unit 34.

The parameter sensing portion 134 of the tire-based unit 34 includes one or more sensors operable for sensing one or more parameters of the tire 16. The parameter sensing portion 134 of the tire-based unit 34 illustrated in FIG. 3 includes a temperature sensor 150, a pressure sensor 152, and other sensors 154. The temperature sensor 150 is operable for sensing temperature within the associated tire 16 and providing temperature signals. The pressure sensor 152 is operable for sensing pressure within the associated tire 16 and for providing pressure signals. The other sensors 154 are operable for sensing other parameters of either the associated tire 16 or the tire-based unit 34 and for providing other parameter signals indicative of the sensed other parameters. For example, the other sensors 154 may include a voltage sensor for determining a supply voltage within the tire-based unit 34.

The parameter sensing portion 134 of the tire-based unit 34 also includes a controller 158. The controller 158 is preferably a microcomputer. Alternatively, the controller 158 may be formed from discrete circuitry, an application-specific-integrated-circuit (“ASIC”), or any other type of control circuitry. The controller 158 is operatively coupled to the temperature sensor 150, the pressure sensor 152, and the other sensors 154 and receives the temperature signals, pressure signals, and other parameter signals, respectively. The controller 158 performs a tire parameter sensing algorithm and outputs a message packet that includes the sensed parameters of the tire 16. As shown schematically in FIG. 3, the controller 158 includes an internal timer 160.

A memory 162 is operatively coupled to the controller 158. Alternatively, the memory 162 may form a portion of the controller 158. The memory 162 is a non-volatile memory in which the tire parameter sensing algorithm for the tire-based unit 34 is stored.

The controller 158 and the memory 162 also form a portion of the communication portion 136 of the tire-based unit 34. The communication portion 136 also includes receive circuitry 166 and transmit circuitry 168. The receive circuitry 166 is operatively coupled to the controller 158 and includes appropriate signal conditioning components (not shown), such as filters and amplifiers, and also includes a demodulator (not shown). The demodulator of the receive circuitry 166 is operable for removing message packets that may be modulated onto the signals received by the antenna 130 of the tire-based unit 34. The receive circuitry 166 provides the message packets to the controller 158.

The transmit circuitry 168 is also operatively coupled to the controller 158. The transmit circuitry 168 includes components for communicating message packets that include the sensed tire parameters to the reader portion 60. For example, when the tire-based unit 34 communicates with the reader portion 60 using backscatter modulation, the transmit circuitry 168 may include a shorting transistor that is applied across the antenna 130 and that has the effect of changing the reflectivity of the antenna. By changing the reflectivity of the antenna 130, a message packet provided by the controller 158 will be modulated onto energy that the antenna 130 reflects back toward the reader portion 60. FIG. 3 schematically illustrates a signal that includes a message packet having the sensed parameters of the tire 16 and that is transmitted from the antenna 130 to the reader portion 60 as parameter signal 44.

When the reader portion 60 of the vehicle-based unit 54 receives a signal, such as the parameter signal 44, from the tire-based unit 34, the received signal is passed through the received signal conditioning circuitry 120 of the reader portion 60 and is transferred to the receive circuitry 110 of the central portion 56 of the vehicle-based unit 54. The receive circuitry 110 demodulates the received signal and sends the message packet received from the signal to an associated input of the controller 96. The controller 96 associates the received message packet to the reader portion 60 from which the signal was received. As a result, the controller 96 of the vehicle-based unit 54 may associate the data regarding the sensed parameters of tire 16 with the location on the vehicle of reader portion 60. The controller 96 may include the sensed parameters and the associated tire location in a display signal that is provided to the display 102. The display 102 may then be responsive to receipt of the display signal for providing an indication of the sensed parameters and the associated tire location.

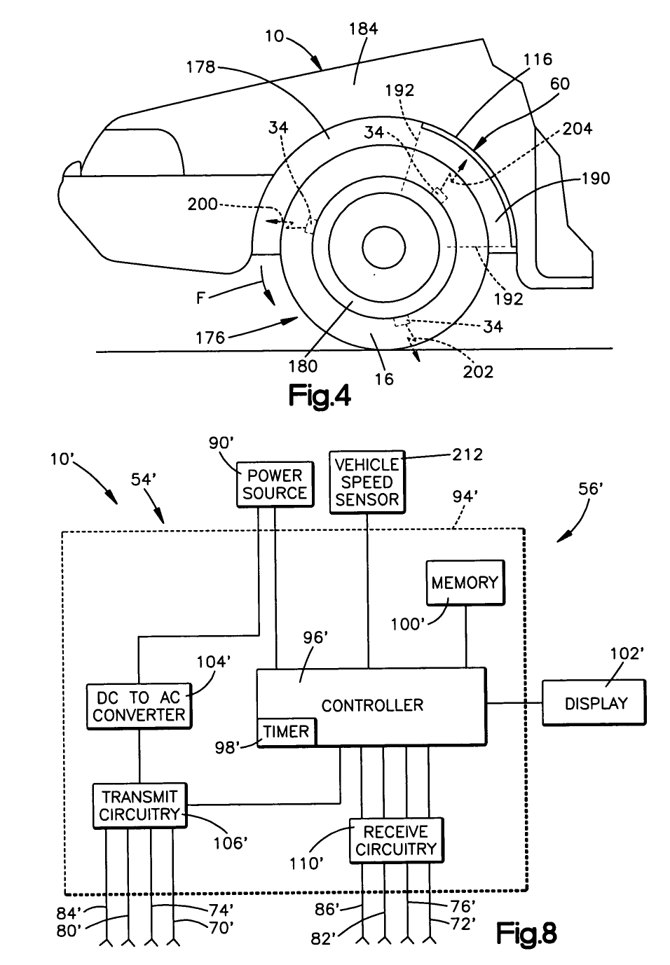

FIG. 4 illustrates a wheel assembly 176 that is located at the front left corner location of the vehicle 10. The wheel assembly 176 is located in an associated wheel well 178 of the vehicle 10 and includes a rim 180 upon which tire 16 is mounted. During vehicle movement, the wheel assembly 176 rotates within the wheel well 178 and relative to a body 184 of the vehicle 10. When the vehicle 10 is moving in a forward direction, the wheel assembly 176 rotates in the direction indicated in FIG. 4 by arrow F in FIG. 4. When the vehicle 10 is moving in a rearward direction, the wheel assembly 178 rotates in the direction opposite arrow F. Since the tire-based unit 34 is fixed relative to the rim 180 of the wheel assembly 176, the tire-based unit 34 rotates with the wheel assembly 176 relative to the body 184 of the vehicle 10. Dashed lines in FIG. 3 illustrate the tire-based unit 34 at various locations relative to the body 184 of the vehicle 10 during rotation of the wheel assembly 176.

FIG. 4 also illustrates the antenna 116 of the reader portion 60 mounted to the body 184 of the vehicle 10 within the wheel well 178. In the embodiment illustrated in FIG. 4, the antenna 116 is a coil antenna. A communication zone 190 is defines in the area between the antenna 116 and the rim 180 of the wheel assembly 176. In the embodiment of FIG. 4, the communication zone 190 is located between dashed lines 192 and extends over approximately seventy percent of the rotation of the wheel assembly 176. Although the communication zone 190 is illustrated as being defined by the boundaries of the antenna 116, the communication zone 190 may extend over an area that is larger than or that is smaller than that of the antenna 116.

During rotation of the wheel assembly 176, the tire-based unit 34 periodically passes into and out of the communication zone 190. Communication of signals between the reader portion 60 of the vehicle-based unit 54 and the tire-based unit 34 is most probable when the tire-based unit 34 is located within the communication zone 190. Communication of signals between the reader portion 60 of the vehicle-based unit 54 and the tire-based unit 34 is less likely to occur when the tire-based unit 34 is located outside of the communication zone 190.

The tire-based unit 34 uses a predetermined amount of the electrical energy for transmitting a tire parameter signal 44. This electrical energy is supplied from the energy storage device 142. When the tire-based unit 34 transmits a tire parameter signal 44 that is not received by the reader portion 60 of the vehicle-based unit 54, the amount of electrical energy stored within the energy storage device 142 may be decreased below an amount necessary for providing another tire parameter signal 44. As a result, the energy storage device 142 may need to be recharged prior to the tire-based unit 34 transmitting another tire parameter signal 44 and the response time of the system to the occurrence of an undesirable tire parameter is lengthened.

The parameter sensing system 12 of the present invention is configured for ensuring that the tire-based unit 34 transmits the tire parameter signal 44 while the tire-based unit 34 is located within the communication zone 190. As a result, the reader portion 60 of the vehicle-based unit 54 is likely to receive the tire parameter signal 44 and a timely indication of the sensed parameters of the tire 16 occurs.

To ensure that the tire-based unit 34 transmits the tire parameter signal 44 while the tire-based unit 34 is located within the communication zone 190, the controller 158 of the tire-based unit 34 controls the tire-based unit 34 to transmit one or more locator signals. Each locator signal has a number of bits that is less than the number of bits of the parameter signal 44. As a result, the amount of electrical energy needed for transmitting the locator signal is less than the amount of electrical energy needed for transmitting the parameter signal 44. The tire-based unit 34 transmits the locator bits at spaced intervals.

The reader portion 60 of the vehicle-based unit 54 is configured to receive the locator signal and to transfer the locator signal to the central portion 56 of the vehicle-based unit. In the central portion 56 of the vehicle-based unit 54, the receive circuitry 110 demodulates the locator signal and sends a message packet indicating receipt of the locator signal to the controller 96. The controller 96 is responsive to the message packet indicating receipt of the locator signal for controlling the vehicle-based unit 54 to transmit a trigger signal to the tire-based unit 34. The trigger signal indicates to the tire-based unit 34 that the locator signal was received and that the tire-base unit is likely located within the communication zone 190.

The trigger signal is received by the antenna 130 of the tire-based unit 34 and is transferred to the receive circuitry 166. The receive circuitry 166 demodulates the trigger signal and provides a message packet indicative of the trigger signal to the controller 158 of the tire-based unit 34. The controller 158 of the tire-based unit 34 is responsive to receipt of the message packet indicating receipt of the trigger signal for controlling the tire-based unit 34 for transmitting the parameter signal 44.

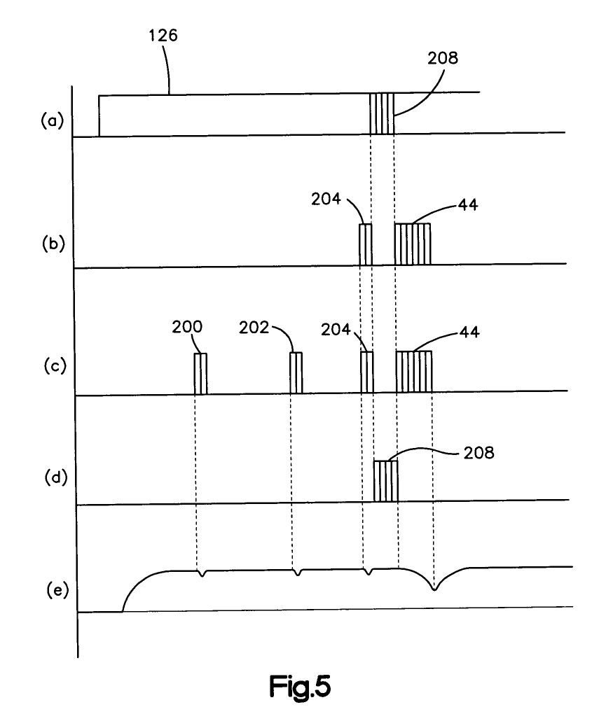

FIG. 5, lines (a)-(d) graphically illustrate the signals that are transmitted by the reader portion 60 of the vehicle-based unit 54 and by the tire-based unit 34. FIG. 5, line (a) illustrates signals transmitted from the reader portion 60. FIG. 5, line (b) illustrates signals received by the reader portion 60. FIG. 5, line (c) illustrates signals transmitted from the tire-based unit 34. FIG. 5, line (d) illustrates signals received by the tire-based unit 34. FIG. 5, line (e) illustrates the stored energy of the energy storage device 142 of the tire-based unit 34.

As shown in FIG. 5, line (a), the reader portion 60 transmits signal 126 to the tire-based unit 34. As shown in FIG. 5, line (e), the amount of energy stored in the energy storage device 142 of the tire-based unit 34 increases in response to the reader portion 60 transmitting signal 126. FIG. 5, line (e) also shows that the amount of energy stored in the energy storage device 142 decreases in response to the transmission of signals from the tire-based unit 34.

FIG. 5, line (c) illustrates the tire-based unit 34 transmitting three locator signals 200, 202, and 204 and one parameter signal 44. The tire-based unit 34 may transmit any number of locator signals. FIG. 4 schematically illustrates an example in which the tire-based unit 34 transmits three locator signals 200, 202, and 204. The first and second locator signals 200 and 202 are transmitted when the tire-based unit 34 is located outside of the communication zone 190. As a result, as shown with reference to FIG. 5, line (b), the reader portion 60 of the vehicle-based unit 54 does not receive the first and second locator signals 200 and 202. As shown in FIG. 4, the tire-based unit 34 transmits the third locator signal 204 while located in the communication zone 190. As a result, the reader portion 60 receives the locator signal 204, as shown in FIG. 5, line (b). The reader portion 60 is responsive to receipt of the locator signal 204 for transmitting the trigger signal 208. FIG. 5, line (a) schematically illustrates the trigger signal 208 modulated onto signal 126. The tire-based unit 34 receives the trigger signal 208, as shown in FIG. 5, line (d), and is responsive to receipt of the trigger signal 208 for transmitting the parameter signal 44, as shown in FIG. 5, line (c).

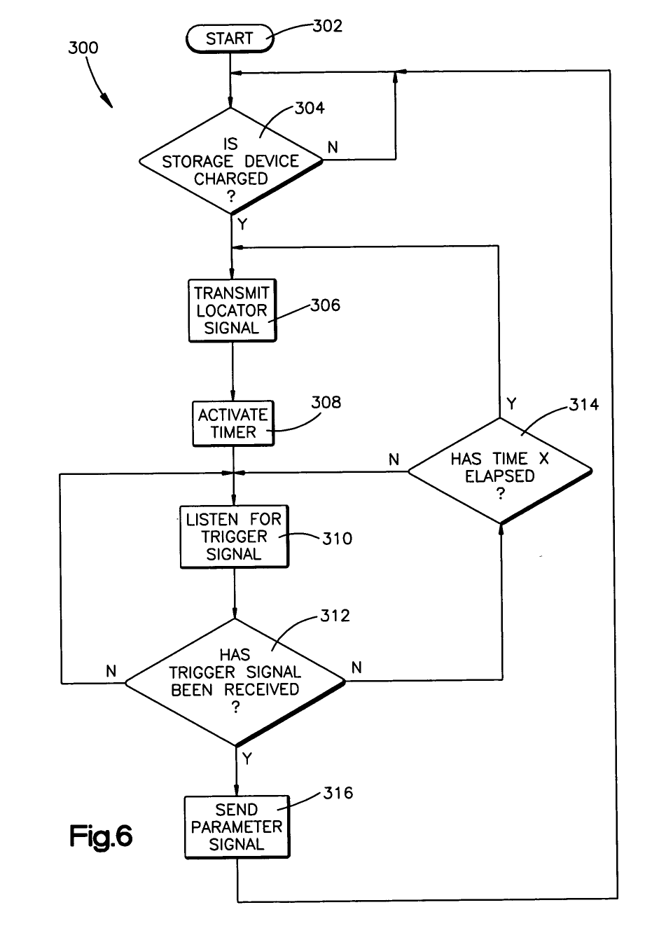

FIG. 6 is a flow diagram illustrating an exemplary process 300 performed by a tire-based unit, such as tire-based unit 34, of the tire parameter sensing system of the present invention. The process begins at step 302 in response to the tire-based unit being magnetically or electrically coupled to an associated reader portion and receiving electrical energy. At step 304, a determination is made as to whether the energy storage device of the tire-based unit is charged. For example, when the energy storage device is a capacitor, a determination is made at step 304 as to whether the capacitor is fully charged or is charged to a predetermined level. When the determination at step 304 is negative and the energy storage device is not charged, step 304 is repeated until the energy storage device is charged. When the determination at step 304 is affirmative and the energy storage device is charged, the process 300 proceeds to step 306.

At step 306, the tire-based unit transmits a locator signal. At step 308, the tire-based unit activates its timer. The process 300 proceeds from step 308 to step 310 in which the tire-based unit listens for a trigger signal from its associated reader portion of the vehicle-based unit. At step 312, a determination is made as to whether a trigger signal has been received. When the determination at step 312 is negative, the process 300 proceeds to step 314. At step 314 a determination is made as to whether a predetermined amount of time, indicated as X in FIG. 6, has elapsed since the timer was activated at step 308. When the determination at step 314 is affirmative and the predetermined amount of time X has elapsed, the process 300 returns to step 306 and the tire-based unit transmits another locator signal. When the determination at step 314 is negative and the predetermined amount of time X has not elapsed, the process 300 returns to step 310 and the tire-based unit continues to listen for a trigger signal.

When the determination at step 312 is affirmative and the tire-based unit has received a trigger signal, the process 300 proceeds to step 316. At step 316, the tire-based unit transmits its tire parameter signal indicating the sensed parameters of its associated tire. From step 316, the process 300 returns to step 304.

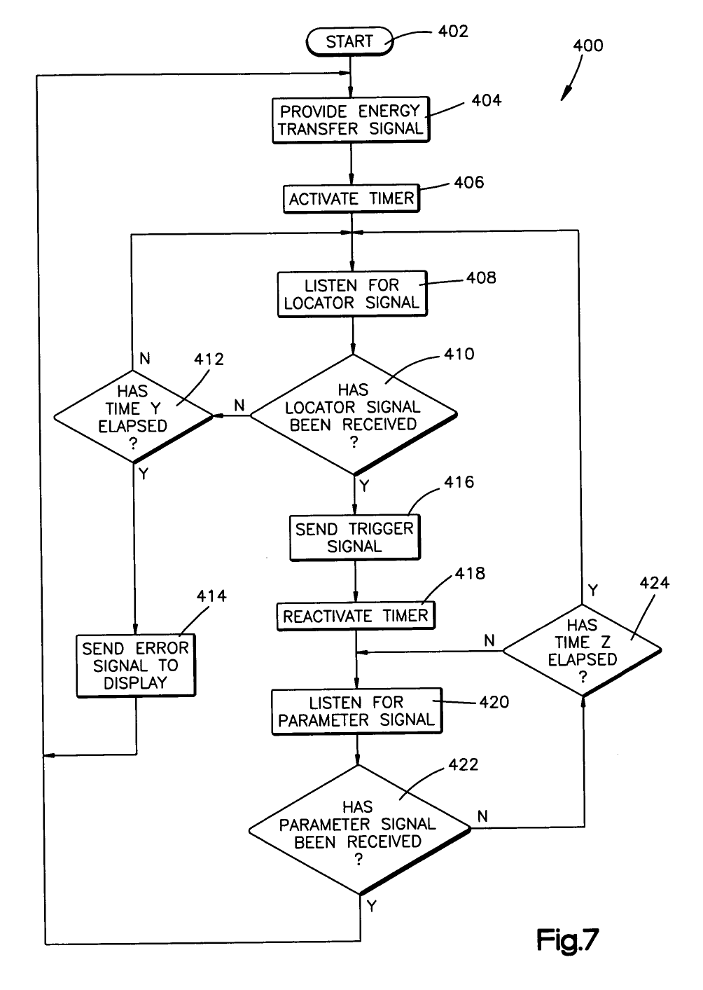

FIG. 7 is a flow diagram illustrating an exemplary process 400 performed by a vehicle-based unit of the tire parameter sensing system of the present invention. The process 400 begins at step 402. At step 404, the vehicle-based system transmits an energy transfer signal to energize an associated tire-based unit. At step 406, the vehicle-based unit activates a timer and, at step 408, the vehicle-based unit listens for a locator signal from the tire-based unit. At step 410, a determination is made as to whether a locator signal has been received. When the determination at step 410 is negative, the process 400 proceeds to step 412 in which a determination is made as to whether a predetermined amount of time, indicated as Y in FIG. 7, has elapsed since the timer was activated. When the determination at step 412 is negative and the predetermined amount of time Y has not elapsed, the process 400 returns to step 408 and continues listening for a locator signal. When the determination at step 412 is affirmative and the predetermined amount of time Y has elapsed, the process 400 proceeds to step 414 in which an error signal is sent to the display to indicate a malfunction of the tire parameter sensing system. From step 414, the process 400 returns to step 404.

When a locator signal is received at the vehicle-based unit and the determination at step 410 is affirmative, the process 400 proceeds to step 416 in which the vehicle-based unit transmits a trigger signal. At step 418, the timer is reactivated and, at step 420, the vehicle-based unit listens for a parameter signal. From step 420, the process 400 proceeds to step 422 in which a determination is made as to whether a parameter signal has been received. When the determination at step 422 is negative, the process 400 proceeds to step 424 in which a determination is made as to whether a predetermined amount of time, indicated as Z in FIG. 7, has elapsed since the timer was reactivated at step 418. When the determination at step 424 is negative, the process 400 returns to step 420 and the vehicle-based unit continues to listen for a parameter signal. When the determination at step 424 is affirmative, the process 400 returns to step 408 and the vehicle-based unit listens for another locator signal.

When the determination at step 422 is affirmative and the vehicle-based system has received a parameter signal, the process 400 returns to step 404. During the process 400 of FIG. 7, the vehicle-based unit may continuously provide the energy transfer signal. Alternatively, the vehicle-based unit may only provide the energy transfer signal for a predetermined amount of time. When the vehicle-based unit only provides the energy transfer signal for a predetermined amount of time, the process returns to step 404 in response to a negative determination at step 412 and after an affirmative determination at step 424. The process ends when the tire parameter sensing system is turned off, such as when the vehicle ignition is turned off.

FIG. 8 is a schematic block diagram of a central portion 56′of a vehicle-based unit 54′ of a tire parameter sensing system 12′ constructed in accordance with a second embodiment of the present invention. The structure of FIG. 8 that are the same as or similar to those previously described with reference to FIG. 2 are labeled with the same reference numbers with the addition of a prime and are not describe again with reference to FIG. 8.

The vehicle-based unit 54′ of FIG. 8 has an associated vehicle speed sensor 212. The vehicle speed sensor 212 senses a speed of the vehicle and provides vehicle speed signals indicative of the sensed speed to the controller 96′. The vehicle speed sensor 212 may be any known type of vehicle speed sensor. In response to receiving vehicle speed signals, the controller 96′ of the vehicle-based unit 54′ modulates vehicle speed data onto the signals, such as signal 126 of FIG. 3, that are transmitted to the associated tire-based units. The tire-based units are responsive to receipt of the vehicle speed data for determining an appropriate interval between the transmissions of locator signals, when more than one locator signal is to be transmitted. For example, a tire-based unit may decrease the amount of time between transmissions of locator signals in response to an increase in vehicle speed. By decreasing the amount of time between transmissions of locator signals, a locator signal is more likely to be transmitted when the tire-based unit is located in a communication zone with the associated reader portion of the vehicle based unit 54′.

From the above description of the invention, those skilled in the art will perceive improvements, changes and modifications. Such improvements, changes and modifications within the skill of the art are intended to be covered by the appended claims.

Having described the invention, I claim the following:

1. A tire parameter sensing system for a vehicle, the system comprising:
a vehicle-based unit; and
a tire-based unit, the tire-based unit being associated with a tire of the vehicle and rotating with the tire, the tire-based unit being located in a communication zone for communicating with the vehicle-based unit through only a portion of each rotation of the tire, the tire-based unit sensing at least one parameter of the tire and transmitting locator signals at predetermined intervals,
the vehicle-based unit receiving a locator signal that is transmitted while the tire-based unit is located in the communication zone and, in response to receiving the locator signal, transmitting a trigger signal to the tire-based unit,
the tire-based unit being responsive to receipt of the trigger signal for transmitting a parameter signal indicative of the sensed at least one parameter.

2. The tire parameter sensing system of claim 1 wherein the locator signal has fewer bits than the parameter signal.

3. The tire parameter sensing system of claim 1 wherein the vehicle-based unit includes a reader portion that is mounted to the vehicle in a location near the tire-based unit, the reader portion including an antenna for transmitting signals to the tire-based unit and receiving signals from the tire-based unit.

4. The tire parameter sensing system of claim 3 wherein the tire-based unit receives power from the vehicle-based unit.

5. The tire parameter sensing system of claim 4 wherein the antenna of the reader portion of the vehicle-based unit is inductively coupled to an antenna of the tire-based unit.

6. The tire parameter sensing system of claim 3 wherein the vehicle-based unit includes a controller, the controller associating signals received from the reader portion to a particular tire location of the vehicle.

7. The tire parameter sensing system of claim 1 wherein the vehicle-based unit has an associated vehicle speed sensor for sensing a speed of the vehicle and providing signals indicative of the sensed vehicle speed, the vehicle-based unit transmitting vehicle speed data to the tire-based unit, the tire-based unit being responsive to the vehicle speed data for controlling a time period of the predetermined interval of locator signal transmissions.

8. A tire parameter sensing system for a vehicle, the system comprising:
a tire-based unit associated with a tire of the vehicle and rotating with the tire;
a vehicle-based unit having a reader portion mounted on the vehicle at a location near the tire to which the tire-based unit is associated, the vehicle-based unit being configured to communicate with the tire-based unit when the tire-based unit is located in a communication zone with the reader portion, the tire-based unit being located in the communication zone with the reader portion through only a portion of each rotation of the tire;
the tire-based unit including a parameter sensing portion for sensing at least one parameter of the tire and a communication portion for communicating with the vehicle-based unit;
the communication portion of the tire-based unit transmitting locator signals at predetermined intervals, the vehicle-based unit being responsive to receipt of a locator signal for transmitting a trigger signal from the reader portion to the tire-based unit, the communication portion of the tire-based unit, in response to receiving the trigger signal, transmitting to the vehicle-based unit a parameter signal indicative of the at least one parameter of the tire.

9. The tire parameter sensing system of claim 8 wherein the locator signal has fewer bits than the parameter signal.

10. The tire parameter sensing system of claim 8 wherein the tire-based unit receives power from the vehicle-based unit.

11. The tire parameter sensing system of claim 10 wherein the antenna of the reader portion of the vehicle-based unit is inductively coupled to an antenna of the tire-based unit.

12. The tire parameter sensing system of claim 8 wherein the vehicle-based unit includes a controller, the controller associating signals received from the reader portion to a particular tire location of the vehicle.

13. The tire parameter sensing system of claim 8 wherein the vehicle-based unit has an associated vehicle speed sensor for sensing a speed of the vehicle and providing signals indicative of the sensed vehicle speed, the vehicle-based unit transmitting vehicle speed data to the tire-based unit, the tire-based unit being responsive to the vehicle speed data for controlling a time period of the predetermined interval of locator signal transmissions.

14. A method of operating a tire parameter sensing system of a vehicle in which a tire-based unit is associated with a tire of the vehicle and rotates with the tire, the tire-based unit being located in a communication zone with a vehicle-based unit through only a portion of each rotation of the tire, the method comprising the steps of
sensing, with the tire-based unit, at least one parameter of the tire;
transmitting locator signals from the tire-based unit at predetermined intervals;
transmitting a trigger signal from the vehicle-based unit to the tire-based unit in response to receipt of a locator signal at the vehicle-base unit, and
transmitting a parameter signal indicative of the at least one parameter of the tire from the tire-based unit to the vehicle-based unit in response to receipt of the trigger signal at the tire-based unit.

15. The method of claim 14 further including the step of transferring power from the vehicle-based unit to the tire-based unit.

16. The method of claim 15 wherein the step of transferring power from the vehicle-based unit to the tire-based unit further includes the step of inductively coupling an antenna of the vehicle-based unit to an antenna of the tire-based unit.

17. The method of claim 14 further including the steps of sensing a speed of the vehicle; transmitting vehicle speed data to the tire-based unit, and controlling a time period of the predetermined interval of locator signal transmissions using the vehicle speed data.
